(19) United States
(12) Patent Application Publication
(10) Pub. No.: US 2006/0240855 A1
(43) Pub. Date: Oct. 26, 2006

(54) Systems and methods for updating presence in a mobile communication network

(76) Inventor: Amit Kalhan, La Jolla, CA (US)

Correspondence Address: KYOCERA WIRELESS CORP., P.O. BOX 928289, SAN DIEGO, CA, 92192-8289, US

(21) Appl. No.: 11/112,492

(22) Filed: Apr. 22, 2005

(51) Int. Cl. H04B 7/00; H04Q 7/20

(52) U.S. Cl. 455/518

(57) ABSTRACT

A mobile communication device is configured to use peer-to-peer communication to update presence information for the associated subscriber. Peer-to-peer communication bypass the network and reduce network overhead and reduce bandwidth consumption. The mobile communication device can also be configured to provide updated presence information to the network, whenever there is a change in presence.

### BACKGROUND

1. Field of the Inventions

The field of the invention relates generally to mobile communication devices and more particularly to managing presence information for mobile communication device in a mobile communication network.

2. Background Information

Push-to-talk capability in mobile communication devices has become more and more popular. Consequently, push-to-talk capability is being incorporated into a larger number of mobile communication devices, such as cellular type telephones. Push-to-talk is a feature that allows a mobile communication device to function as a two-way radio in much the same manner as a walkie-talkie. Generally, push-to-talk operation involves half-duplex communication, i.e., only one subscriber can speak at a time; however, push-to-talk has proved very popular for short, quick communication, especially when the parties are in close proximity. In essence, push-to-talk capability allows subscribers to communicate simply by pushing a button and speaking into their mobile communication device.

Presence plays a significant role in push-to-talk communication. The term “presence” refers to a list of subscribers that are currently accepting push-to-talk communications. Presence for a specific subscriber can comprise the subscriber's push-to-talk number, which is typically different from the subscriber's ordinary mobile number. Presence can further comprise a name, or moniker assigned to the subscriber, e.g., by the subscriber on whose device the presence list appears. Thus, when the subscriber accesses his presence list, he can see a list of push-to-talk numbers and/or names of push-to-talk subscribers. When the subscriber desires to initiate a push-to-talk communication with one of the subscribers in the presence list, the subscriber can, e.g., scroll to the subscriber's name or number and then push the push-to-talk button on the subscriber's device, which will cause the device to initiate a push-to-talk communication with the selected subscriber.

Thus, presence provides a subscriber with knowledge of what other subscribers are accepting push-to-talk communications so that they can avoid failed calls. Presence also provides quick access to contact information for subscribers that are accepting calls.

The mobile communication network manages presence in conventional systems. The mobile communication network maintains a list of subscribers within the network that are accepting push-to-talk communications. The network is configured to push the presence list out to subscribers with push-to-talk capability. The subscribers can join, or specify groups for which their presence information can be made available. The network then periodically polls the communication devices within a group. If there has been a change in the status for particular device, i.e., the subscriber has indicated a willingness to receive push-to-talk communications, or a desire not to receive further push-to-talk communications, then the device can respond to the polling with the updated status. Once the network has received the updated status for the device, it will push out the updated presence information to all of the push-to-talk devices within the group.

It can be seen that present methods for maintaining and updating presence can result in burdensome administrative overhead and consume valuable bandwidth within the network. This problem is only being exacerbated as more and more subscribers switch to mobile communication devices with push-to-talk capability.

### SUMMARY OF THE INVENTION

A mobile communication device is configured to use peer-to-peer communication to update short localized network administration information, such as presence information for the associated subscriber or location information for a particular user. Peer-to-peer communication bypass the network and reduce network overhead and reduce bandwidth consumption.

In one aspect, the mobile communication device can also be configured to provide updated presence information to the network, whenever there is a change in presence.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an example mobile communication system configured in accordance with one embodiment;

FIG. 2 is a flow chart illustrating an example methods for updating presence in the system of FIG. 1 in accordance with one embodiment; and

FIG. 3 is a diagram illustrating an example mobile communication device that can be used in the system of FIG. 1 to implement the method of FIG. 2.

### DETAILED DESCRIPTION

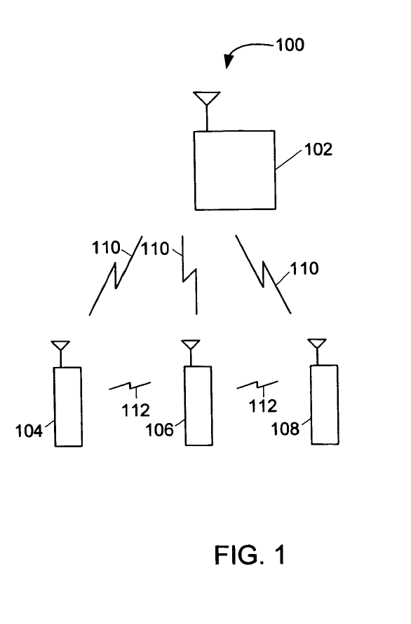

FIG. 1 is a diagram illustrating an example mobile communication network 100 configured in accordance with the systems and methods described herein. Mobile communication network 100 can be a wireless Wide Area Network (WAN), wireless Metropolitan Area Network (MAN), wireless Local Area Network (LAN), or some combination thereof. Mobile communication network 100 can comprises one or more base stations 102 approximately at the center of one or more communication cells (not shown). For ease of illustration, a single base station 102 is shown in FIG. 1; however, this should not be seen as limiting the systems and methods described herein to embodiments comprising a single base station 102.

Mobile communication network 100 also comprises a plurality of mobile communication device in communication with the one or more base stations 102. In the example of FIG. 1, three mobile communication devices 104, 106, and 108 are illustrated communicating with base station 102. Again, this should not be seen as limiting the systems and methods described herein to any particular number of mobile communication devices. Mobile communication devices 104, 106, and 108 communicate with base station 102 over communication channels 110 in accordance with a defined air interface standard.

Communication devices 104, 106, and 108 are configured for push-to-talk operation. Thus, for example, when the subscriber associated with device 104 desires to communicate with the subscriber associated with device 106, the subscriber can initiate a push-to-talk communication via a button on device 104. First, of course, the subscriber can scroll through the presence list contained on device 104 to determine whether the subscriber associated with device 106 is available for push-to-talk communications. Pushing the push-to-talk button will cause device 104 to initiate a communication link 110 with base station 102. This is the uplink. The network will then initiate a corresponding downlink 110 with device 106 thereby completing the link between device 104 and device 106.

The network will provide an indication that can be output to the subscriber via device 104 once the link is completed. Once the subscriber receives the indication, he can then speak into device 104 to communicate with the subscriber associated with device 106.

In a conventional system, links 110 are also used by the network to update the presence lists on devices 104, 106, and 108. Clearly, if links 110 are being used to update presence, they cannot be used for push-to-talk, or other communications, which is what drives revenue for the network operator. Since the network has a finite number of links 110, or bandwidth that it can make use of, using the links to update presence can have a negative impact on the network operator's revenue.

In the systems and methods described herein, however, devices 102, 104, and 106 include alternative communication capability that allows them to communicate directly with each other in what can be termed a peer-to-peer mode, via communication links 112 The alternative communication capability can be configured to operate in accordance with a variety of standardized or custom communication protocols that allow the type of peer-to-peer communication described herein. For example, the alternative communication capability can be based on WiFi, Bluetooth™, or any similar wireless communication standard. Thus, the alternative communication capability must be configured to communicate over links 112 in accordance with the air interface standard associated with the communication standard being used. An example mobile communication device that includes such alternative communication capability is described in detail below.

In system 100, devices 104, 106, and 108 can be configured to exchange presence information via links 112. Generally, links 112 will be relative short range links and, therefore, the sharing of presence information will necessarily be limited to subscribers within a relatively small area; however, push-to-talk communication is generally used over shorter ranges than, e.g., cellular communications, so this should not be a significant draw back. Further, links 112 will generally be better for the transmission of small amounts of one-way data, which can make them ideal for transferring the presence information described herein.

Thus, when a device, e.g., device 104 is to start receiving push-to-talk communications, it can update its presence with the other devices within its group, e.g., device 106 and 108, over links 112. In certain embodiments, device 104 can update its presence with devices 106 and 108 at the same time or serially. In other embodiments, device 104 can update its presence and device 106 can in turn update device 108. For example, if device 108 is out of range of device 104, then device 106 can relay the updated information. In this manner, the change in presence for device 104 can be propagated through out the group. Moreover, in this manner, the presence information can be propagated to devices that are operating outside of the cell in which device 102 is operating, i.e., the information can be propagated to devices communicating with a different base station 102.

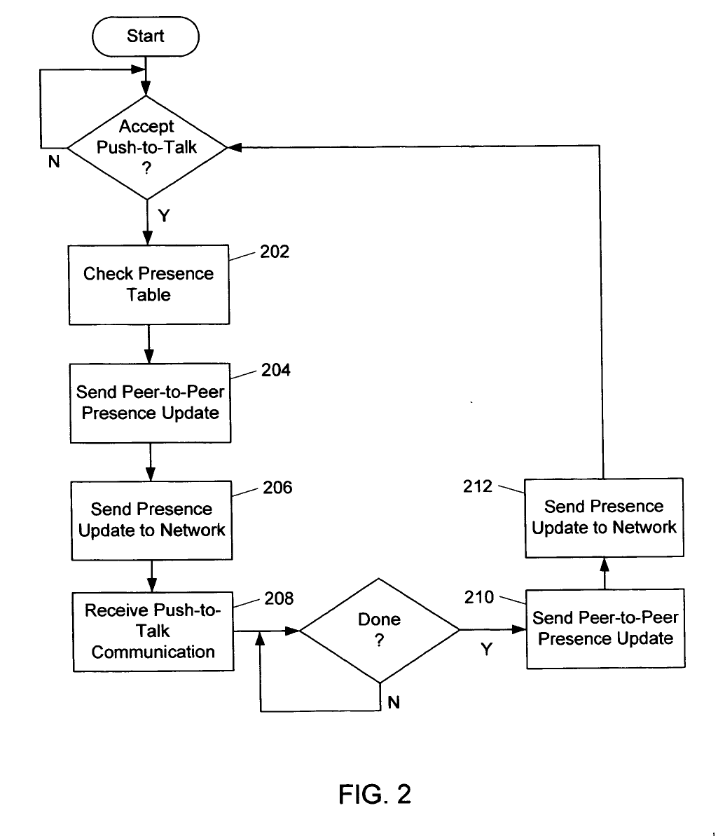

FIG. 2 is a flow chart illustrating an example method for communicating presence data in accordance with one embodiment of the systems and methods described herein. The example of FIG. 2 assumes that a subscriber, e.g., associated with device 102, has decided to start receiving push-to-talk communications. This can be, e.g., after the subscriber has powered on their device, when the subscriber wishes to join a group, or after a period during which the subscriber was not receiving push-to-talk communications. Accordingly, the subscriber's device now has updated presence information that it needs to send to other subscribers in the group, or groups to which the subscriber belongs.

Thus, in step 202, the device can check the presence list stored on the device to see what other devices are accepting push-to-talk communications. The device can then attempt to update each of them with its updated presence information. For example, the device can begin polling each of the devices in the list, serially or via a broadcast. The device can then send the updated presence information to each device that responds to the poll. In turn, these devices can poll other devices and propagate the presence information. In other embodiments, the device can simply broadcast its updated presence to any device within range, which can in turn broadcast the updated information to any deices within their range. Alternatively, the device can simply request presence information from a neighboring device.

Additionally, the device can update the network of its change in presence in step 206. Even though the mobile communication devices can update each other, it can still be important for the network to maintain an updated presence list. For example, when a device first establishes communication with a base station 102 in a given cell, it can download the latest presence list for devices within that cell.

In step 208, the subscriber can then initiate and receive push-to-talk communications. Once the subscriber decides to stop receiving push-to-talk communications, or drops out of a particular group, the subscriber's device can communicate the change in presence to the other devices, in step 210, in much the same way described above. The device can also update the server, in step 212, in the same manner as described above. Alternatively, in one embodiment the device can inform a neighboring device or devices and the neighboring device or devices can propagate that information to other devices within the group.

In this manner, the bandwidth and other resources of system 100 are preserved and revenue impacts can be mitigated.

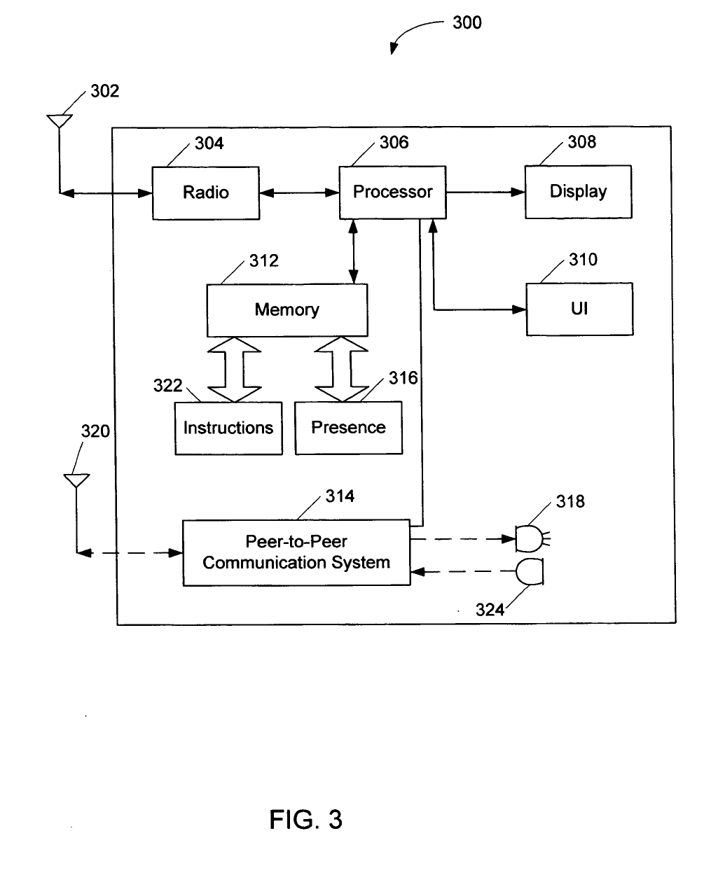

FIG. 3 is a diagram illustrating a example mobile communication device 300 configured to implement the method of FIG. 2 in accordance with one embodiment of the systems and methods described herein. As can be seen, device 300 includes an antenna 302 and a radio 304. Radio 304 can be configured to modulate signals to be transmitted, e.g., over links 110, with a carrier frequency and transmit them via antenna 302. Radio 304 can also be configured to demodulate signals received via antenna 302. Processor 306 can be configured to process the transmit and receive signals.

Processor 306 can comprise multiple processors or processing circuits, such as Digital signal Processors (DSPs), audio processors, math coprocessors, etc. These processors and/or processing circuits can be included in a single Integrated Circuit (IC), or several ICs, and can be packaged in a single chip package or multiple chip packages. Radio 304 can be any standard or customized radio configured to transmit signals wirelessly over the air. Antenna 302 can comprise a single antenna or multiple antennas, e.g., for spatial diversity. In fact antenna 302 can actually comprise one or more arrays of antennas.

Device 300 can also include a memory 312 coupled with processor 306, which can be configured to store instructions 322 and data that can be used by processor 306 to control the operation of device 300. In addition, memory 312 can be configured to store presence information 316 for other devices. Memory 312 can be one or multiple device contained in one ore multiple circuit packages. For example, memory 312 can include static or dynamic memory, erasable memory, removable memory, etc.

Device 300 also includes a user interface 310 that can, e.g., be used by a subscriber to scroll through and select a push-to-talk subscriber from the presence information 316 and to initiate a communication with the selected subscriber. User interface can also be used by the subscriber to indicate a change in presence status, e.g., a desire to join or drop out of a group. Display 308 can be used, e.g., to display the presence information as well as other information.

In addition, device 300 can comprise communication system 314 that can be used for peer-to-peer communication, e.g., over links 112, as described above. As mentioned above, communication system 314 can be configured for short range, wireless communication. Thus, system 314 can comprise the front end circuitry required to communicate over communication link 112 as well as the backend processing needed to encode and decode communications received over link 112. In alternative embodiment, some or all of the backend processing can be implemented by processor 306. Similarly, in certain embodiments, portions of the front end circuitry can be shared with radio 304. For example, components such as mixers, filters, amplifiers, an oscillator circuits an signals can be shared between system 314 and radio 304 depending on the embodiment.

The front end circuitry can in certain embodiments be configured to use the same antenna 302 as is used by radio 304. In other embodiments, system 314 can be interfaced with its own antenna 320. In certain embodiments, optical communication links 112 can be used for the peer-to-peer communication described above. In such cases, the front end circuitry can be configured to drive light source 318 and optical detector 324. Optical interfaces tend to be line of sight, however, which can reduce their effectiveness.

Thus, device 300 can be configured to engage in push-to-talk communications over links 110 using radio 304 and antenna 302. Device 300 can also receive updated presence information from the network via antenna 302 and radio 304. The presence information can then be stored in memory 312 and displayed on display 308. Presence for device 300 can, however, be updated via communication system 314 over links 112. This can comprise transmitting updated presence for device 300 and receiving updated presence for other devices.

Several examples have been discussed with respect to presence. Other short localized network administrative information can also be shared using peer-to-peer communication. For example, location of a particular device can be shared using peer-to-peer communication. Location information about particular device can, in one embodiment, facilitate future transmissions between that device and neighboring devices. Other examples can include velocity of a particular device, estimated time when a particular device may not be available for future communication, and a reporting list of neighboring devices.

While certain embodiments and/or implementations of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A mobile wireless communication device, comprising:
a push-to-talk communication system configured to send and receive push-to-talk communications; and
a peer-to-peer communication system configured to communicate network administrative information for the mobile wireless communication device to other mobile communication devices.

2. The mobile wireless communication device of claim 1, wherein the network administrative information comprises presence information.

3. The mobile wireless communication device of claim 1, wherein the network administrative information comprises location information.

4. The mobile wireless communication device of claim 2, further comprising a user interface and a processor interfaced with the user interface, wherein a subscriber can input a change of presence through the user interface, and wherein the processor is configured receive the change in presence from the user interface and cause the peer-to-peer communication system to update other mobile communication devices with the change in presence information.

5. The mobile wireless communication device of claim 4, wherein the processor is further configured to update a network with the change in presence via the push-to-talk communication system.

6. The mobile wireless communication device of claim 2, wherein the peer-to-peer communication system is configured to receive updated presence information from other mobile wireless communication devices.

7. The mobile wireless communication device of claim 6, further comprising a memory configured to store the updated presence information for the other mobile communication devices.

8. The mobile wireless communication device of claim 1, wherein the peer-to-peer communication system is a short range wireless communication system.

9. The mobile wireless communication device of claim 8, wherein the short range wireless communication system is a WiFi system.

10. The mobile wireless communication device of claim 8, wherein the short range wireless communication system is a Bluetooth™ system.

11. The mobile wireless communication device of claim 8, wherein the short range wireless communication system is a wideband CDMA system.

12. The mobile wireless communication device of claim 8, wherein the short range wireless communication system is an optical communication system system.

13. The mobile wireless communication device of claim 6, further comprising a processor, wherein the processor is configured to send the updated presence information for another mobile communication device to still other mobile communication devices via the peer-to-peer communication system.

14. A method for updating presence in a mobile communication system, comprising:
receiving an change in presence indication;
communicating the change in presence via a peer-to-peer communication system; and
communicating the change in presence to a network via a push-to-talk communication system.

15. The method of claim 14, wherein the change of presence is to begin accepting push-to-talk communications, and wherein the method further comprises receiving push-to-talk communications.

16. The method of claim 15, further comprising receiving an indication the push-to-talk communications will not be received, and communicating the new change in presence via a peer-to-peer communication system.

17. The method of claim 16, further comprising communicating the new change in presence to a network via a push-to-talk communication system.

18. The method of claim 14, further comprising receiving update presence via the peer-to-peer communication system.

19. The method of claim 18, further comprising storing the updated presence information received via the peer-to-peer communication system.

20. The method of claim 18, further comprising transmitting the updated presence information received via the peer-to-peer communication system.

21. A mobile wireless communication device, comprising:
a push-to-talk means for sending and receiving push-to-talk communications; and
a peer-to-peer communication means for communicating presence information for the mobile communication device to other mobile communication devices.

22. The mobile wireless communication device of claim 21, further comprising a means for inputting a change of presence and a processing means for receiving the change in presence and causing the peer-to-peer communication means to update other mobile communication devices with the change in presence information.

23. The mobile wireless communication device of claim 22, wherein the processing means is further for updating a network with the change in presence via the push-to-talk means.

24. The mobile wireless communication device of claim 21, wherein the peer-to-peer communication means is further for receiving updated presence information from other mobile communication devices.

25. The mobile wireless communication device of claim 24, further comprising a memory configured to store the updated presence information for the other mobile communication devices.
